(19) United States
(12) Patent Application Publication
(10) Pub. No.: US 2023/0161119 A1
(43) Pub. Date: May 25, 2023

(54) MULTICONFIGURATION ISOLATOR WAVELENGTH DIVISION MULTIPLEXER

(71) Applicant: Cisco Technology, Inc., San Jose, CA (US)

(72) Inventor: Colm V. Cryan, Newport (IE)

(73) Assignee: Cisco Technology, Inc., San Jose, CA (US)

(21) Appl. No.: 17/994,121

(22) Filed: Nov. 25, 2022

Related U.S. Application Data
(60) Provisional application No. 63/282,760, filed on Nov. 24, 2021.

(51) Int. Cl. G02B 6/42

(52) U.S. Cl. CPC G02B 6/4207

(57) ABSTRACT

In part, the disclosure relates to an apparatus that may include a first lens; wherein the first lens is enabled to be optically connected to an optical fiber; an isolator core optically coupled to the first lens; a second lens optically coupled to the isolator core; wherein the second lens is enabled to be optically connected to another optical fiber; wherein the isolator core is enabled to allow optical power from the first lens to propagate through the isolator core; wherein the isolator core is enabled to block optical power from the second lens from propagating through the isolator core; a first optical filter optically coupled to the first lens; and a second optical filter optically coupled to the second lens; wherein the second optical filter is enabled to reflect a first frequency; wherein the isolator core is enabled to absorb a remaining portion of the first frequency.

### CROSS REFERENCE TO RELATED APPLICATION

This application claims priority to and the benefit of U.S. Provisional Patent Application No. 63/282,760 filed Nov. 24, 2021, the disclosure of which is herein incorporated by reference in its entirety.

### FIELD

This disclosure relates generally to the field of integrated circuits.

### BACKGROUND

Contemporary optical communications and other photonic systems make extensive use of photonic components that are advantageously mass-produced in various configurations for various purposes.

### SUMMARY

In part, in one aspect, the disclosure relates to various isolator wavelength division multiplexer (IWDM) embodiments and IWDM-based systems and methods. In part, in another aspect, the disclosure relates to an apparatus that may include a first lens; wherein the first lens is enabled to be optically connected to an optical fiber; an isolator core optically coupled to the first lens; a second lens optically coupled to the isolator core; wherein the second lens is enabled to be optically connected to another optical fiber; wherein the isolator core is enabled to allow optical power from the first lens to propagate through the isolator core; wherein the isolator core is enabled to block optical power from the second lens from propagating through the isolator core; a first optical filter optically coupled to the first lens; and a second optical filter optically coupled to the second lens; wherein the second optical filter is enabled to reflect a first frequency; wherein the isolator core is enabled to absorb a remaining portion of the first frequency.

In some embodiments, the first optical filter and the second optical filter have different transmission and reflection spectra. In many embodiments, the apparatus may further include a second EDFA optically connected to the isolator core opposite a first EDFA. In some embodiments, the first lens is enabled to be optically connected to a plurality of optical fibers; wherein the second lens is enabled to be optically connected to a plurality of other optical fibers.

In various embodiments, a first portion of the plurality of optical fibers are of a first refractive index profile and material composition; wherein a second portion of the plurality of optical fibers are of a second refractive index profile and material composition. In some embodiments, a first portion of the plurality of other optical fibers are of a first refractive index profile and material composition; wherein a second portion of the plurality of other optical fibers are of a second refractive index profile and material composition.

In many embodiments, a first portion of the plurality of optical fibers are enabled be an input; wherein a second portion of the plurality of optical fibers are enabled to be an output. In various embodiments, both the first optical filter and the second optical filter are optical gratings. In some embodiments, both the first filter and the second filter are dielectric filters.

In some embodiments, the optically directional filter is tuned to directionally permit a specific wavelength. In some embodiments, the optically directional filter is tuned to directionally reject a specific wavelength. In some embodiments, optical power is enabled to flow into the first lens from at least one optical fiber; wherein optical power is enabled to flow out of the second lens to at least one other optical fiber.

In some embodiments, optical power is enabled to flow into at least one optical fiber from the first lens; wherein optical power is enabled to flow out of at least one other optical fiber to the second lens. In many embodiments, optical power of a first wavelength is enabled to flow into the first lens from at least one optical fiber; wherein optical power of a second wavelength is enabled to simultaneously flow out of the first lens into the at least one optical fiber.

In some embodiments, optical power of a first wavelength is enabled to flow out of the second lens into at least one optical fiber; wherein optical power of a second wavelength is enabled to simultaneously flow into the second lens from the at least one optical fiber. In various embodiments, the isolator core is configured to operate in at least four modes: isolator mode, WDM mode; Isolator-WDM mixed mode; and Reverse-WDM mode. In many embodiments, the first lens is enabled to connect to two inputs, wherein the second lens is enabled to connect to two outputs.

In some embodiments, the first lens is enabled to connect to four inputs; wherein the second lens is enabled to connect to four outputs. In various embodiments, the first lens is enabled to connect to at least six inputs; wherein the second lens is enabled to connect to at least six outputs. In some embodiments, the apparatus may further include a second isolator core connected to a first EDFA, wherein the isolator core and the second isolator core are each connected to separate optical fibers.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation. Further, the various apparatus, optical elements, coatings/layers, etches, optical paths, waveguides, splitters, couplers, combiners, electro-optical devices, inputs, outputs, ports, channels, components and parts of the foregoing disclosed herein can be used with any laser, laser-based communication system, waveguide, fiber, transmitter, transceiver, receiver, and other devices and systems without limitation.

These and other features of the applicant's teachings are set forth herein.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings in which:

FIG. 1 illustrates schematic paths of signals through an isolator core flowing from input optical pigtails to output optical pigtails, in an embodiment of the current disclosure;

FIG. 2a illustrates a logical path of signals through an isolator core flowing from input optical pigtails to output optical pigtails, in an embodiment of the current disclosure;

FIG. 2b illustrates a physical path of signals through an isolator core flowing from input optical pigtails to output optical pigtails, in an embodiment of the current disclosure;

FIG. 3a illustrates the flow of optical power through an isolator core which is configured as a bidirectional single IWDM, in an embodiment of the current disclosure;

FIG. 3b is a table which illustrates how optical power may flow into and out of an isolator which is configured as a bidirectional single IWDM such as is illustrated and described with respect to FIG. 3a, in an embodiment of the current disclosure;

FIG. 4a is a schematic diagram which illustrates a traditional implementation of bidirectional optical power through two IWDMs;

FIG. 4b illustrates a schematic diagram of an isolator core which is configured as a bidirectional single IWDM, in an embodiment of the current disclosure;

FIG. 5a illustrates a logical path of signals through an eight-fiber IWDM, flowing from input optical pigtails to output optical pigtails in an embodiment of the current disclosure;

FIG. 5b illustrates a physical path of signals through an isolator core configured as an eight-fiber IWDM in an embodiment of the current disclosure;

FIG. 6a illustrates a isolator core which is configured as a unidirectional IWDM and dual-isolator configuration, in an embodiment of the current disclosure;

FIG. 6b is a table which illustrates the flow of optical power through an isolator core which is configured as a unidirectional dual-IWDM, in an embodiment of the current disclosure;

FIG. 7a is a schematic diagram which illustrates a traditional implementation of an IWDM and a dual-isolator;

FIG. 7b is a schematic diagram which illustrates an isolator core configured as a unidirectional dual-IWDM, in an embodiment of the current disclosure;

FIG. 8a illustrates the flow of optical power through an isolator core which is configured as a unidirectional IWDM and a dual-isolator, in an embodiment of the current disclosure;

FIG. 8b is a table which illustrates how optical power may flow through an isolator-core, configured as a unidirectional dual-IWDM and dual isolator, such as is illustrated and described with respect to FIG. 8a, in an embodiment of the current disclosure;

FIG. 9a is a schematic diagram which illustrates a traditional implementation of achieving optical power flow using three isolator cores;

FIG. 9b is a schematic diagram which illustrates an isolator core configured as one bidirectional dual-IWDM, in an embodiment of the current disclosure;

FIG. 10a illustrates the flow of optical power through an isolator core configured as a unidirectional dual-IWDM, in an embodiment of the current disclosure;

FIG. 10b is a table which illustrates how optical power may flow through an isolator core configured as a unidirectional dual-IWDM such as is illustrated and described with respect to FIG. 10a, in an embodiment of the current disclosure;

FIG. 11a is a schematic diagram which illustrates a traditional implementation of achieving optical power flow using two isolator cores;

FIG. 11b is a schematic diagram which illustrates an isolator core configured as two unidirectional IWDMs, in an embodiment of the current disclosure;

FIG. 12a illustrates the flow of optical power in an isolator core configured as a bidirectional dual-IWDM, in an embodiment of the current disclosure;

FIG. 12b is a table which illustrates how optical power may flow through an isolator core configured as a bidirectional dual-IWDM, such as is illustrated and described with respect to FIG. 12a, in an embodiment of the current disclosure;

FIG. 13a is a schematic diagram which illustrates a traditional implementation of achieving optical power flow using four isolator cores;

FIG. 13b is a schematic diagram which illustrates an isolator core configured as bidirectional dual-IWDM, in an embodiment of the current disclosure;

FIG. 14 illustrates the flow of optical power in an isolator core configured as a twelve-fiber multiconfiguration IWDM, in an embodiment of the current disclosure.

### DETAILED DESCRIPTION

In various embodiments, the disclosure may relate to a design and implementation of optical components (e.g., isolator wavelength division multiplexer (IWDM)) and maybe operable such that optical power propagates through the isolator core in one direction. In certain embodiments, the propagation direction may be from input to output. In most embodiments, a wavelength division multiplexing function may combine optical power at different wavelengths into a single optical fiber pigtail. In certain embodiments, different wavelengths may be a signal wavelength and a pump wavelength. In most embodiments, a signal wavelength and a pump wavelength may be enabled to travel in the same direction. In some embodiments, a signal wavelength and a pump wavelength may be enabled to travel in the opposite direction. In some embodiments, a signal wavelength and a pump wavelength may be enabled to co-propagate. In some embodiments, a signal wavelength and a pump wavelength may be enabled to counter-propagate. In most embodiments, an IWDM may be part of an erbium Doped Fiber Amplifier (EDFA) core. In various embodiments, the IWDM may couple pump optical power into an erbium doped fiber (EDF). In most embodiments, the pump optical power may be converted to signal optical power which may amplify the signal optical power travelling through the fiber.

Typically, in the manufacture of an EDFA core, parameters such as small size, low noise figure (NF), low-cost, low re-splice requirement and/or increased reliability, are desirable. Typically, an EDFA core is assembled using components such as IWDMs, EDF and isolators. Generally, IWDMs have three fiber pigtails; an input pigtail through which the optical signal to be amplified enters the IWDM; a pump pigtail through which the optical power that is used to amplify the input signal enters the IWDM and an output pigtail where both the input signal and pump power exit the IWDM.

Conventionally, EDFA cores have erbium doped fiber (EDF) where pump power is converted to signal power thereby amplifying the input signal relative to what was received at the input pigtail of the IWDM. Typically, a signal optical power to be amplified is connected to an input pigtail of an EDFA, may travel through the IWDM, erbium doped fiber (EDF), and isolator before exiting the EDFA core via an output pigtail. Generally, an increase in signal power is achieved by converting pump power, which may be provided to the EDFA by means of a pump pigtail, to signal power. Traditionally, an IWDM combines a signal power and a pump power into a single output pigtail.

In many embodiments, Applicants realize that it may be desirable to inject pump optical power into the EDF from both ends of a fiber. In certain embodiments, Applicants realize it may be desirable to inject pump optical power between two ends of an EDF to increased signal gain and reduce the optical signal-to-noise ratio (OSNR). In various embodiments, Applicants realize that a single EDFA core with mirrors tuned to reflect or pass certain wavelengths of light may provide the same effects as two separated EDFA cores and pumps. In most embodiments, combining the EDFA cores into a single core may considerably reduce the physical footprint of the circuit. In most embodiments, a single EDFA core may be for two pumps and thus may reduce the overall insertion loss and increase the OSNR and efficiency of the circuit.

In many embodiments, an EDF may be provided on a spool and/or routed within the package containing an EDFA core. In certain embodiments, an EDF used in an EDFA core may be a length of uniform diameter erbium doped fiber. In some embodiments, an EDF may convert a pump power to a signal power. In most embodiments, an isolator may prevent a signal and/or pump power from travelling in a reverse direction through an EDFA core. In various embodiments, isolators may have two fiber pigtails; an input pigtail through which the amplified optical signal enters the isolator and an output pigtail where the optical signal exits the isolator. In various embodiments, optical power may flow from an input pigtail to the output pigtail of an isolator. In some embodiments, certain wavelengths of light may not flow from the output pigtail to the input pigtail of an isolator core.

In certain embodiments, no optical power may flow from an output pigtail to an input pigtail of an isolator core. In certain embodiments, a partially reflective mirror or grating may prevent certain wavelengths of light from entering an isolator core. In most embodiments, isolators may be designed such that input, and output pigtails, have the same properties (e.g., same cladding diameter, single mode fibers (SMF) at appropriate wavelengths and non-erbium doped fibers (non-EDF.) In various embodiments, properties of an EDF (e.g., cladding diameter, mode field diameter (MFD), erbium doped concentration and/or number of modes supported) may differ from fiber used on the IWDM pigtails and/or the isolator pigtails.

In certain embodiments, in packaging of an EDFA core for use in a system, it may be desirable that components take up as little space as possible (e.g., the amount of fiber used may be minimized, and/or the fiber may be bent into tight radius of curvature, and/or the diameter of the fiber may be small.) In some embodiments, an EDF may be selected to have a smaller cladding diameter to reduce a size of a fiber coil in an EDFA core to facilitate a low bend radius of curvature. In addition, in some embodiments, an EDF may have erbium doped in a core and/or cladding region and may support multiple modes at a pump wavelength (e.g., 980 nm and/or 1480 nm.)

In various embodiments, an EDFA core may include an IWDM, EDF, and an isolator. In certain embodiments, an EDFA core may include a different arrangement and/or selection of components. In some embodiments, an IWDM may combine optical power from a signal to be amplified that enters through an IWDM input pigtail and multiplexed with pump optical power. In certain embodiments, a non-EDF pigtail may be joined to an ‘EDF’ pigtail by means of a ‘splice.’ In various embodiments, a ‘splice’ may reduce the amount of optical power transmitted through a ‘splice’ by about 5-10% of the transmitted optical power. In some embodiments, Pump power in an EDF may be transferred to an input signal which may be amplified and exit an EDFA core with more power than at an IWDM's input pigtail. In some embodiments, signal optical power may enter through an IWDM and may be combined with pump optical power. In certain embodiments, signal power and pump power may be combined by multiplexing the signals together. In certain embodiments, the combined signal and pump optical powers may propagate in the opposite direction to the signal in the EDF. In many embodiments, an amplified signal from an EDFA core may pass through a series of components, such as a tunable optical filter (TOF) that may remove noise power outside a signal wavelength range, a variable optical attenuator (VOA) that may control a power level of an amplified signal, and a PIN-tap that may measure a power level of an amplified signal. In various embodiments, components located outside an EDFA core may use pigtails that are different from an EDF.

In many embodiments, performance of an EDFA core may be improved by inserting pump optical power into both the input end and output end of the EDF from which it may be constructed. In various embodiments, the EDF in the EDFA core may be cut into two lengths, and arranged such that the signal optical power travels from an input to an output of the first length. In some embodiments, signal optical power may travel from an input to an output of the second length. In most embodiments, a signal may travel from a first length output into a second length input. In some embodiments, at the place where the signal exits the first length and enters the second length, an optical power pump may be inserted.

In various embodiments, an optical power pump may be connected to an output of the first length and an input of the second length. In some embodiments, more than one EDFA may be used. In various embodiments, each EDFA may have an independent IWDM. In certain embodiments an EDFA may include an IWDM and one or more isolators may be required. In some embodiments, a size of an EDFA core may be reduced by combining multiple functions into a single component. In certain embodiments, a noise function (NF) and/or gain of an EDFA core may be improved by maintaining pump optical power along the length of EDF by inserting pump optical power in both the input and output ends of the EDF. In certain embodiments, a noise function (NF) and/or gain of an EDFA core may be improved by maintaining pump optical power along the length of EDF by inserting pump optical power between the input and output ends of the EDF.

In some embodiments, a NF may be a measure of degradation of the optical signal-to-noise ratio (OSNR) which may be caused by components in an optical path of the EDFA core and/or fiber used to form pigtails and/or splices used to join the pigtails. In various embodiments, signal power loss and pump power loss may be reduced in the EDFA core by modifying one or more of the components used to manufacture the EDFA core, such as: reduction in the number of times the optical power of the signal goes from an input fiber pigtail to an output fiber pigtail, elimination of one or more splices, elimination of isolator cores in the EDFA core.

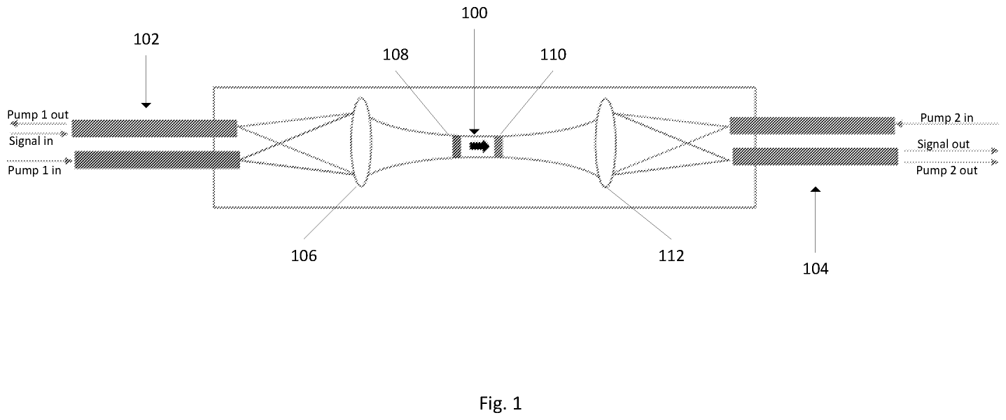

Refer now to the example embodiment of FIG. 1, which illustrates schematic paths of signals through an isolator core 100 flowing from input optical pigtails 102 to output optical pigtails 104. In general, references to optical pigtails herein may also include or otherwise be replaced or substituted with various waveguides, optical inputs, optical outputs, optical channels, optical paths, and devices. The signal path may also include a set of components such as an input lens 106, an input filter 108, an output filter 110 and an output lens 112.

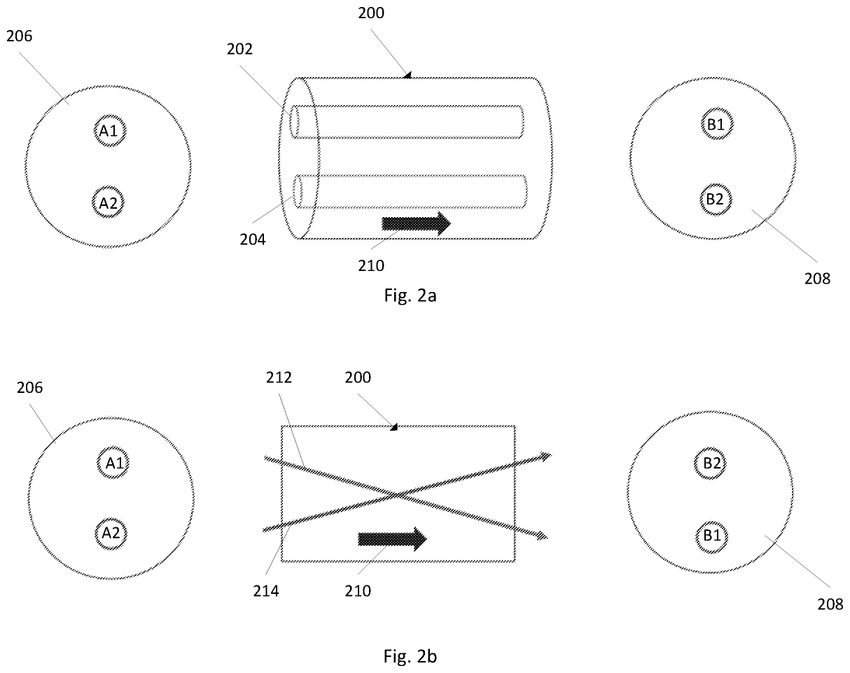

Refer now to the example embodiment of FIG. 2a which illustrates a logical path of signals through an isolator core 200 flowing from input optical pigtails 206 to output optical pigtails 208. In various embodiments, the input optical pigtail 206 includes two signal inputs A1 and A2. In various embodiments, the output optical pigtail 208 includes two signal outputs B1 and B2. Schematic paths through the core are shown as parallel. A first schematic signal path 202 flows from A1 to B1, and a second schematic signal path 204 flows from A2 to B2 through the isolator core 200. Optical power may flow the same direction as the arrow 210, or from the input optical pigtail 202 to the output optical pigtail 204. In some embodiments, some wavelengths of light may flow from Ai to Bi while other wavelengths of light may flow from Ai to Bi and from Bi to Ai where i is 1 or 2.

Refer now to the example embodiment of FIG. 2b which illustrates a physical path of signals through the isolator core 200 flowing from input optical pigtails 206 to output optical pigtails 208. Physical paths are centrally symmetric through the isolator core 200. The first physical signal path 212 flows from position A1 to B1 and the second physical signal path 214 flows from position A2 to B2 through the isolator core 200. The lenses in the isolator core may cause the signals to “flip,” as illustrated in FIG. 2b in comparison to a logical/schematic path similar the illustration and description of FIG. 2a. Optical power may flow the same direction as the arrow 210, or from the input optical pigtail 202 to the output optical pigtail 204. In certain embodiments, some wavelengths of optical power may flow from Ai to Bi while other wavelengths of light may flow from Ai to Bi and from Bi to Ai where i is 1 or 2.

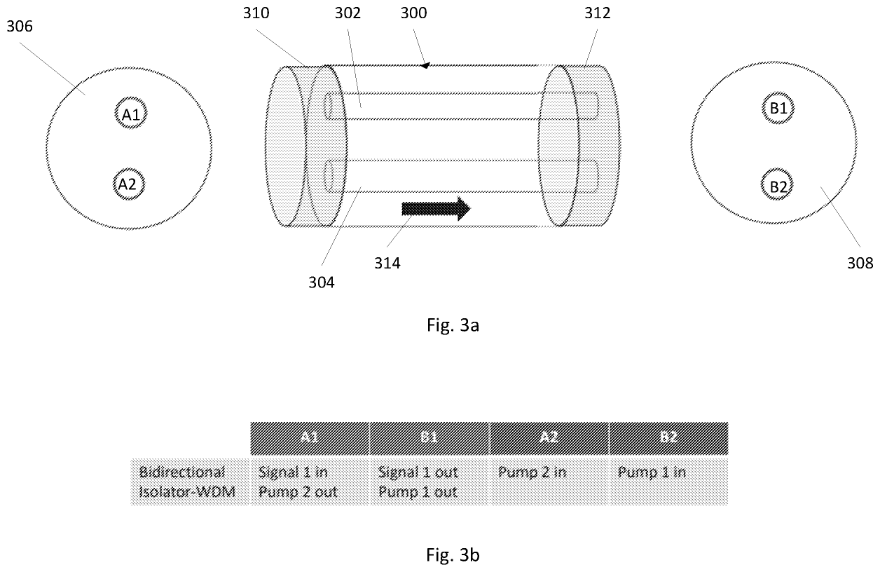

Refer now to the example embodiment of FIG. 3a which illustrates the flow of optical power through an isolator core 300 which is configured as a bidirectional single IWDM. In various embodiments, the input optical pigtail 306 includes two signal inputs A1 and A2. In various embodiments, the output optical pigtail 308 includes two signal outputs B1 and B2. A first signal wavelength 302 at A1 may flow to B1, and a second signal wavelength 304 at A2 may flow to B2. In various embodiments, the pump reflectors 310, 312 are configured to select light having a wavelength of 980 nm for reflection or partial reflection. In various embodiments, the pump reflectors 310, 312 are configured to select light having a wavelength of 1480 nm for reflection or partial reflection. Signal optical power may flow the same direction as the arrow 314, or from the input optical pigtail 306 to the output optical pigtail 308. A pump wavelength at A2 may flow to A1 for optical pigtail 306, and a pump wavelength at B2 may flow to B2 for optical pigtail 308.

Refer now to the table FIG. 3b which is a table that illustrates the flow of optical power into and out of an example embodiment, such as the embodiment illustrated and described with respect to FIG. 3a. FIG. 3b illustrates how optical power may flow into and out of an isolator which is configured as a bidirectional single IWDM such as is illustrated and described with respect to FIG. 3a, in an embodiment of the current disclosure;

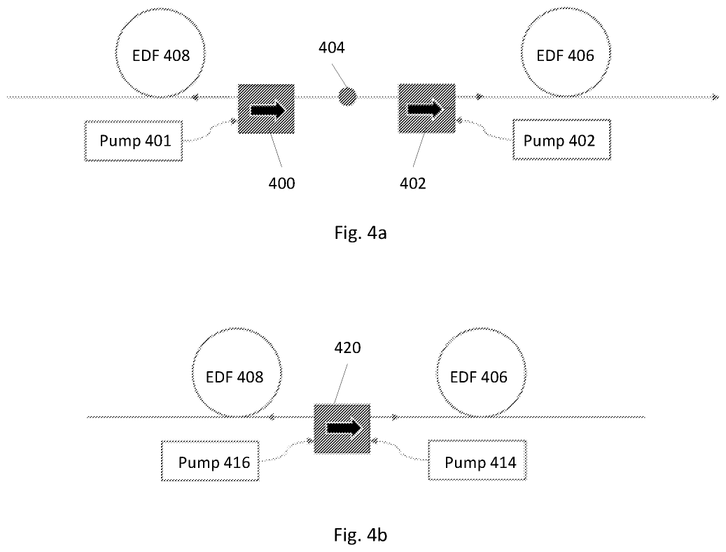

Refer now to FIG. 4a, which illustrates a schematic diagram of a traditional implementation of a bidirectional optical power through two IWDMs 400, 402. This conventional configuration requires two IWDMs 400, 402 and a splice 404. Each EDF 406, 408 is separated by a component or series of components which may perform various operations on the signal between the two pumps 401 402. Applicants realize that components placed in between these two pumps may increase optical signal noise ratio and may reduce efficiency. Applicants also realize that some components traditionally placed between these pumps may reduce signal noise and/or decrease transmission efficiency. Additionally, Applicant realizes the design such as the design illustrated and described with respect to FIG. 4a may occupy a relatively large space.

Refer now to the example embodiment of FIG. 4b, which illustrates a schematic diagram of an isolator core, which is configured as a bidirectional single IWDM that achieves the same functionality as the traditional implementation described in FIG. 4a with a single IWDM 420 and no splices. A single IWDM 420 may be shared by multiple EDFs 408, 406. A shared isolator core may increase efficiency and facilitate signal transmission when compared with the traditional two isolator cores in serial connection, such as is described with respect to FIG. 4a. In FIG. 4b, two pumps 416 and 414 are also used and are in optical communication with IWDM 420.

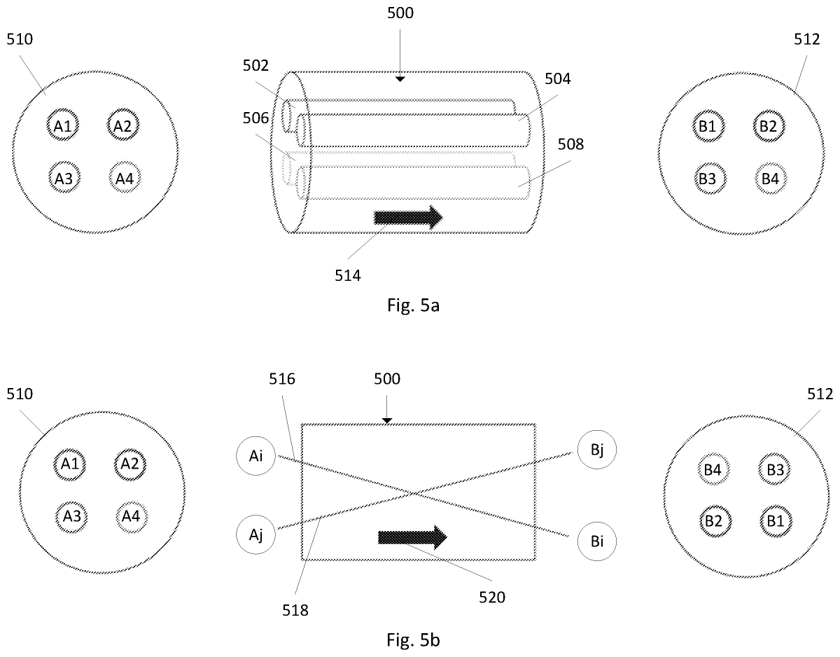

Refer to the example embodiment of FIG. 5a which illustrates a logical path of signals through an isolator core 500 configured as an eight-fiber IWDM, flowing from input optical pigtails 510 to output optical pigtails 512. In various embodiments, the input optical pigtail 510 includes four signal inputs A1, A2, A3, and A4. In various embodiments, the output optical pigtail 512 includes four signal outputs B1, B2, B3 and B4. Schematic paths through the isolation core 500 are shown as parallel. The first schematic signal path 502 may flow from A1 to B1, the second schematic signal path 504 may flow from A2 to B2, the third schematic signal path 506 may flow from A3 to B3, and the fourth schematic signal path 508 may flow from A4 to B4. Signal optical power may flow the same direction as the arrow 514, or from the input optical pigtails 510 to the output optical pigtails 512. Pump wavelength at A3 and A4 may flow to A2 and A1, respectively and pump wavelength at B3 and B4 may flow to B2 and B1, respectively.

Refer now to the example embodiment of FIG. 5b which illustrates a physical path of signals through an isolator core 500 configured as an eight fiber IWDM flowing from a plurality of input optical pigtails 510 to a plurality of output optical pigtails 512. The physical paths are centrally symmetric through the isolator core. The first physical signal path pair 516 may flow from Ai Bi where i is 1 or 2. The second physical signal path pair 518 may flow from Aj to Bj where j is 3 or 4. The lenses in the isolator core may cause the signals to “flip,” as illustrated, in comparison to a logical path similar the illustration and description of FIG. 5a. Signal optical power may flow the same direction as the arrow 520, or from the input optical pigtails 510 to the output optical pigtails 512. In certain embodiments, some wavelengths of optical power may flow from Ai and Aj to Bi and Bj while other wavelengths of light may flow from Ai and Aj to Bi and Bj and from Bi and Bj to Ai or Aj.

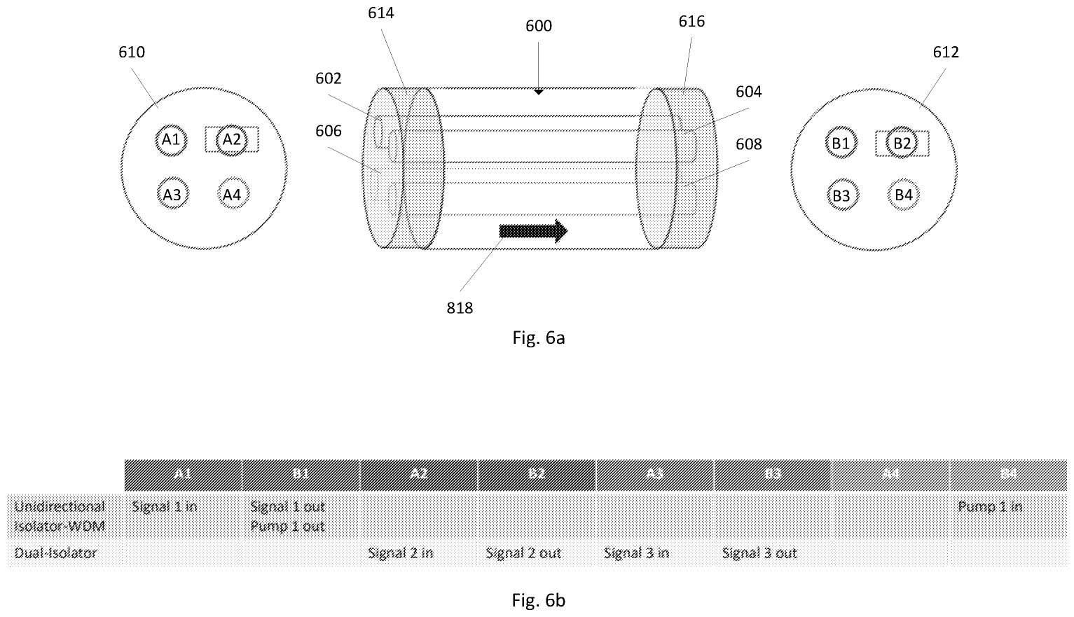

Refer now to the example embodiment of FIG. 6a which illustrates an isolator core 600 which is configured as a unidirectional IWDM and a dual-isolator configuration of the IWDM. Pump reflectors on the input end 614 and output end 616 of the isolator core 600 may allow optical power to flow from an input optical pigtail 610 to an output optical pigtail 612. In various embodiments, the input optical pigtail 610 includes four signal inputs A1, A2, A3, and A4. In various embodiments, the output optical pigtail 612 includes four signal outputs B1, B2, B3 and B4. The first schematic signal path 602 may flow from A1 to B1, the second schematic signal path 604 may flow from A2 to B2, the third schematic signal path 606 may flow from A3 to B3, and the fourth schematic signal path 608 may flow from A4 to B4. In various embodiments, the pump reflectors 614, 616 are configured to select light having a wavelength of 980 nm for reflection or partial reflection. In various embodiments, the pump reflectors 614, 616 are configured to select light having a wavelength of 1480 nm for reflection or partial reflection. Signal optical power may flow the same direction as the arrow 618, or from the input optical pigtails 610 to the output optical pigtails 612. Pump wavelength A3 and A4 may flow to A2 and A1, respectively and pump wavelength at B3 and B4 may flow to B2 and B1, respectively.

Refer now to FIG. 6b, a table which illustrates the flow of optical power through an embodiment of the current disclosure such as is described and illustrated with respect to FIG. 6a. This embodiment may eliminate one component per modem.

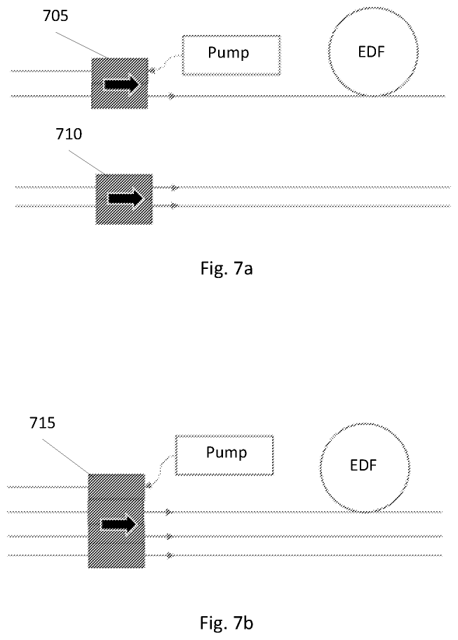

Refer now to FIG. 7a, which illustrates a schematic diagram of a traditional implementation of an IWDM 705 and a dual-isolator 710. The configuration requires two components an IWDM 700 and a dual-isolator 705.

Refer now to the example embodiment of FIG. 7b, which illustrates a schematic diagram of an isolator core configured as a unidirectional dual-IWDM 715. In various embodiments, the unidirectional dual-IWDM 715 achieves the same functionality as the traditional implementation described with respect to FIG. 7a without the additional components.

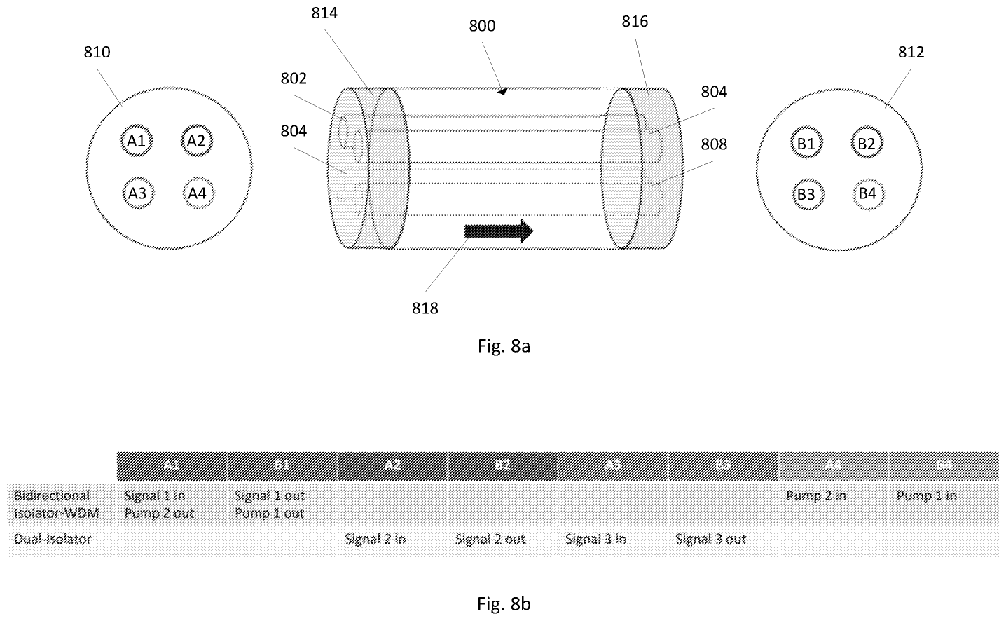

Refer now to the example embodiment of FIG. 8a which illustrates the flow of optical power through an isolator core 800 which is configured as a unidirectional IWDM and a dual-isolator. Pump reflectors on the input end 814 and output end 816 of the isolator core allow optical power to flow from an input optical pigtail 810 to an output optical pigtail 812. In various embodiments, the input optical pigtail 810 includes four signal inputs A1, A2, A3, and A4. In various embodiments, the output optical pigtail 812 includes four signal outputs B1, B2, B3 and B4. The first schematic signal path 802 may flow from A1 to B1, the second schematic signal path 804 may flow from A2 to B2, the third schematic signal path 806 may flow from A3 to B3, and the fourth schematic signal path 808 may flow from A4 to B4. In various embodiments, the pump reflectors 814, 816 are configured to select light having a wavelength of 980 nm for reflection or partial reflection. In various embodiments, the pump reflectors 814, 816 are configured to select light having a wavelength of 1480 nm for reflection or partial reflection. Signal optical power may flow the same direction as the arrow 818 or from the input optical pigtails 810 to the output optical pigtails 812. Pump wavelength at A3 and A4 may flow to A2 and A1, respectively and pump wavelength at B3 and B4 may flow to B2 and B1, respectively.

Refer now to FIG. 8b, a table which illustrates how optical power may flow through an isolator core configured as a unidirectional dual-IWDM and dual-isolator, such as an isolator core as illustrated and described with respect to FIG. 8a. This embodiment may eliminate one component per modem.

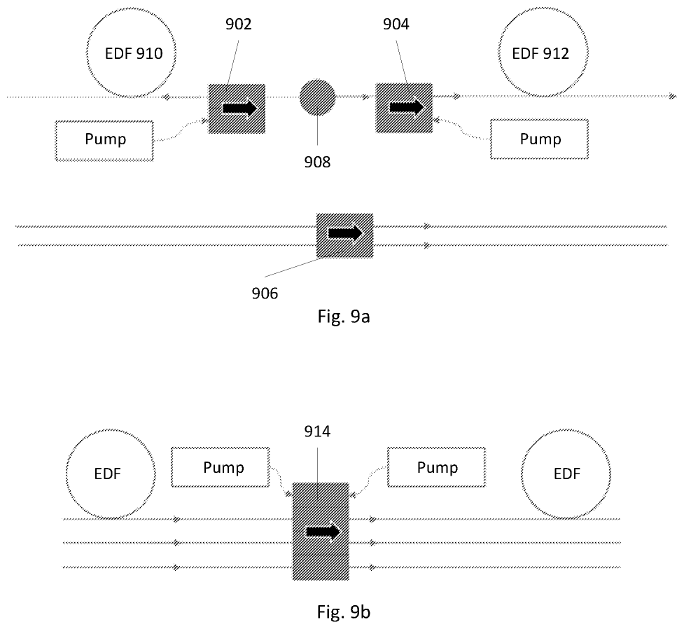

Refer now to FIG. 9a, which illustrates a schematic diagram of a traditional implementation of achieving optical power flow using three isolator cores, consisting of two IWDMs 902, 904, a dual-isolator 906 and a splice 908. Each EDF pump 910, 912 is separated by a component or series of components which typically, but not always, perform various operations on the signal between the two pumps. Applicants realize that components placed in between these two pumps increase optical signal noise ratio and may reduce efficiency. Applicants also realize that some components traditionally placed between these pumps may reduce signal noise and/or decrease transmission efficiency. Additionally, Applicant realizes the design such as is illustrated and described with respect to FIG. 9a occupies a relatively large space.

Refer now to the example embodiment of FIG. 9b which illustrates a schematic diagram of an isolator core configured as one bidirectional dual-IWDM, which achieves the same functionality as the traditional implementation described with respect to FIG. 9a with a single isolator core. Applicants realize that a single isolator core 914 may be shared by more than one pump. A shared isolator core 914 may increase efficiency and facilitate signal transmission when compared with the traditional two isolator cores in serial connection such as is illustrated and described with respect to FIG. 9a.

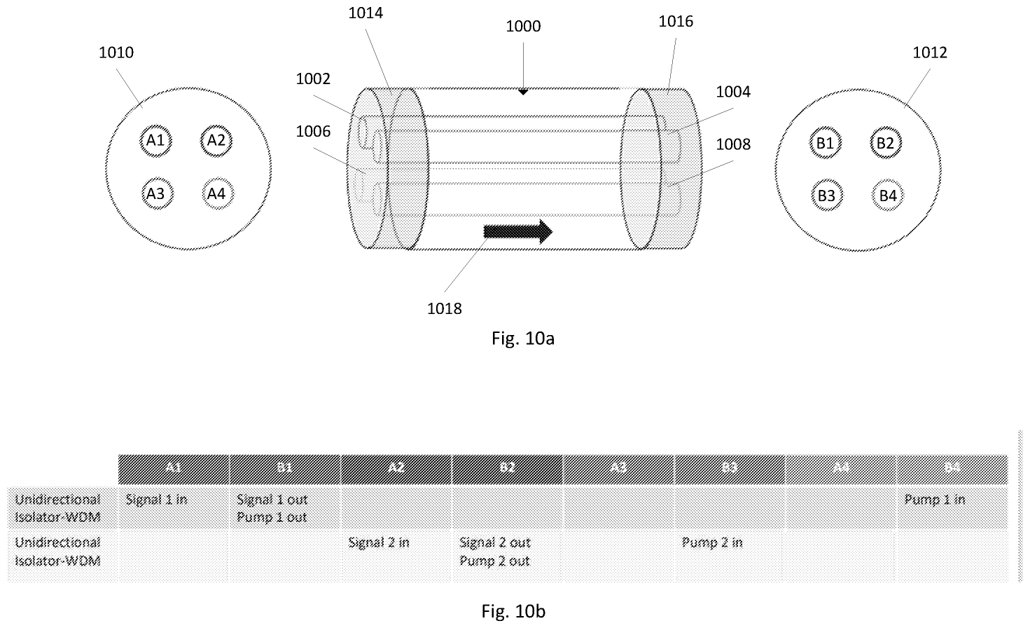

Refer to the example embodiment of FIG. 10a which illustrates the flow of optical power through an isolator core 1000 configured as a unidirectional dual-IWDM. Pump reflectors on the input end 1014 and output end 1016 of the isolator core allowing the flow of optical power from an input optical pigtail 1010 to an output optical pigtail 1012. In various embodiments, the input optical pigtail 1010 includes four signal inputs A1, A2, A3, and A4. In various embodiments, the output optical pigtail 1012 includes four signal outputs B1, B2, B3 and B4. The first schematic signal path 1002 may flow from A1 to B1, the second schematic signal path 1004 may flow from A2 to B2, the third schematic signal path 1006 may flow from A3 to B3, and the fourth schematic signal path 1008 may flow from A4 to B4. In various embodiments, the pump reflectors 1014, 1016 are configured to select light having a wavelength of 980 nm for reflection or partial reflection In various embodiments, the pump reflectors 1014, 1016 are configured to select light having a wavelength of 1480 nm for reflection or partial reflection. Signal optical power may flow the same direction as the arrow 1018, or from the input optical pigtail 1010 to the output optical pigtail 1012. Pump wavelength at A3 and A4 may flow to A2 and A1, respectively and pump wavelength at B3 and B4 may flow to B2 and B1, respectively.

Refer now to FIG. 10b, a table which illustrates how optical power may flow through an isolator core configured as a unidirectional dual-IWDM, such as the example embodiment illustrated and described with respect to FIG. 10a. This embodiment may eliminate 1 component per modem.

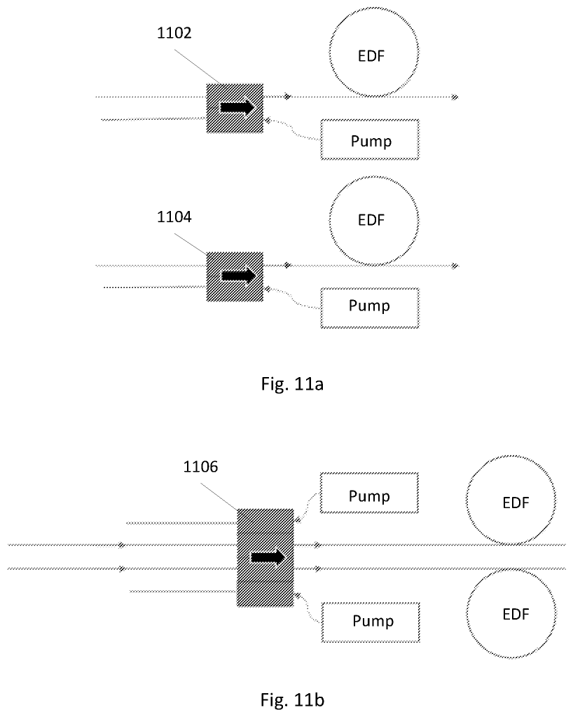

Refer now to FIG. 11a, which illustrates a schematic diagram of the traditional implementation of achieving optical power flow using two isolator cores 1102, 1104. Notably, the traditional implementation consists of two IWDMs.

Refer now to the example embodiment of FIG. 11b, which illustrates an isolator core 1106 configured as a bidirectional dual-IWDM that achieves the same functionality as the traditional implementation described with respect to FIG. 11a with a single isolator core 1106.

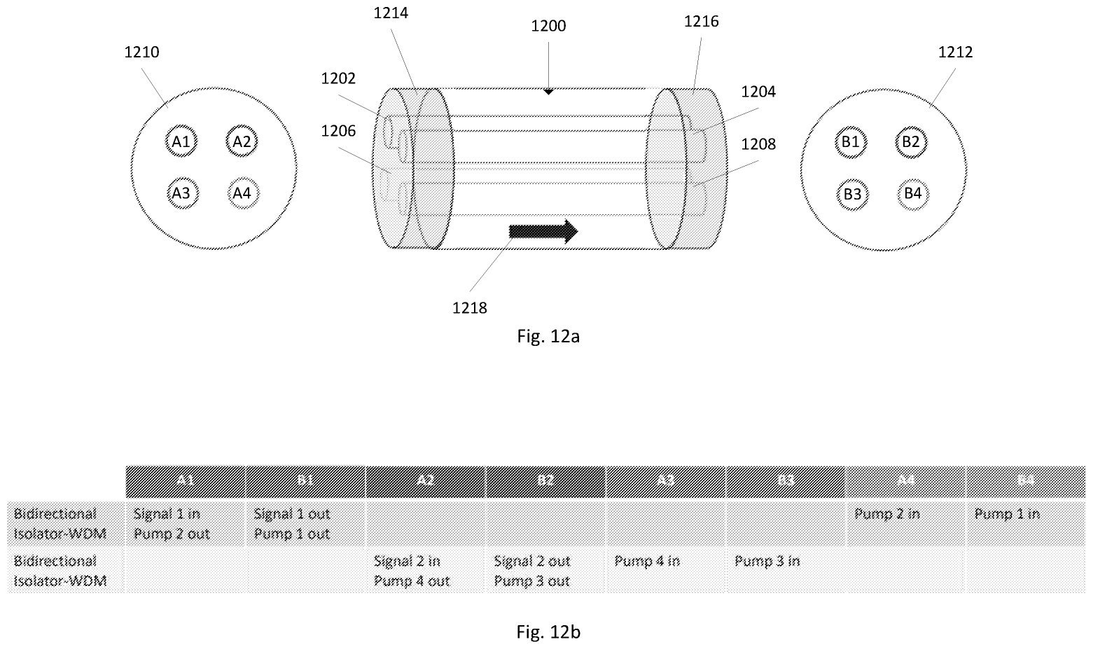

Refer to the example embodiment of FIG. 12a which illustrates the flow of optical power in an isolator core 1200 configured as a bidirectional dual-IWDM. Pump reflectors on the input end 1214 and output end 1216 of the isolator core 1200 allow the flow of optical power from an input optical pigtail 1210 to an output optical pigtail 1212. In various embodiments, the input optical pigtail 1210 includes four signal inputs A1, A2, A3, and A4. In some embodiments, the output optical pigtail 1212 includes four signal outputs B1, B2, B3 and B4. The first schematic signal path 1202 may flow from A1 to B1, the second schematic signal path 1204 may flow from A2 to B2, the third schematic signal path 1206 may flow from A3 to B3, and the fourth schematic signal path 1208 may flow from A4 to B4. Signal optical power may flow the same direction as the arrow 1218, from the input optical pigtail 1210 to the output optical pigtail 1212. Pump wavelength at A3 and A4 may flow to A2 and A1, respectively and pump wavelength at B3 and B4 may flow to B2 and B1, respectively.

Refer now to FIG. 12b, a table which illustrates how optical power may flow through an isolator core configured as a bidirectional dual-IWDM such as the example embodiment illustrated and described with respect to FIG. 12a. This embodiment may eliminate one component per modem.

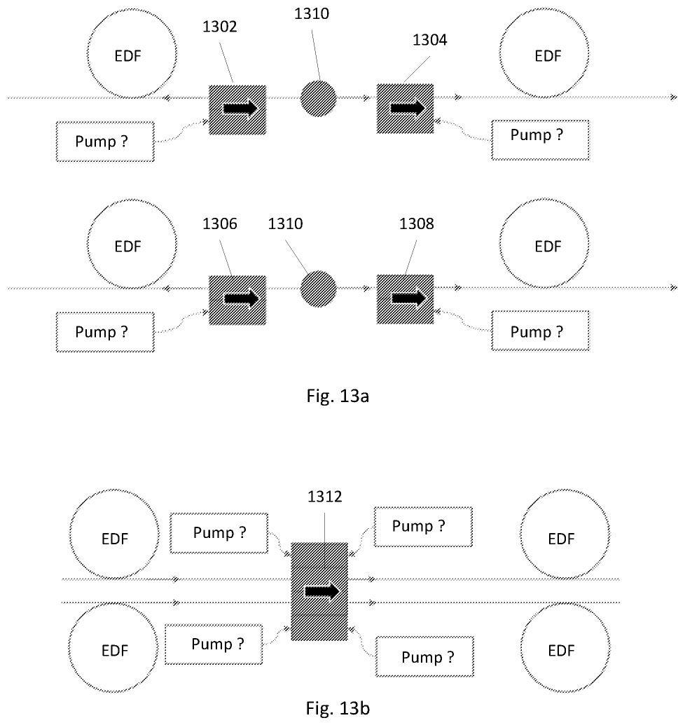

Refer now to FIG. 13a, which illustrates a schematic diagram of a traditional implementation of achieving power flow using four isolator cores 1302, 1304, 1306, 1308 configured as four IWDMs and a splice 1310. Each EDF pump is separated by a component or series of components which typically, but not always, perform various operations on the signal between the two pumps. Applicants realize that components placed in between these two pumps increase optical signal noise ratio and may reduce efficiency. Applicants also realize that some components traditionally placed between these pumps may reduce signal noise and/or decrease transmission efficiency. Additionally, Applicant realizes the design such as is illustrated and described with respect to FIG. 13a occupies a relatively large space.

Refer now to the example embodiment of FIG. 13b, which illustrates an isolator core 1312 configured as a bidirectional dual-IWDM that achieves the same functionality as the traditional implementation described with respect to FIG. 13a. Applicants realize that a single shared isolator core 1312 (such as is illustrated and described with respect to FIG. 13b) may be shared by more than one pump. A shared isolator core 1312 may increase efficiency and facilitate signal transmission when compared with two isolator cores in serial connection, such as is illustrated and described with respect to FIG. 13a.

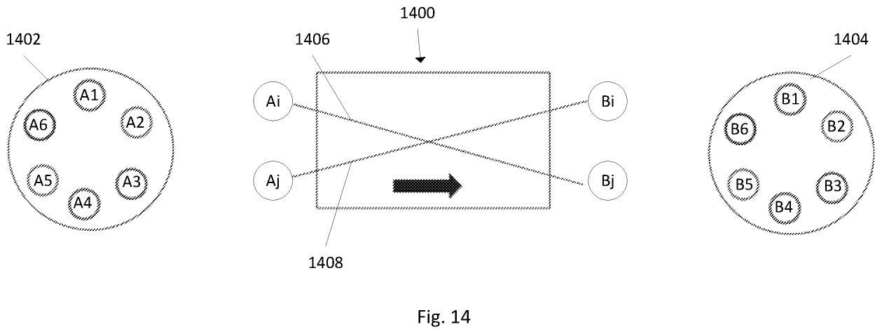

Referring now to the example embodiment of FIG. 14, which illustrates the flow of optical power in an isolator core 1400 configured as a twelve-fiber multiconfiguration IWDM. An isolator core 1400 of the current embodiment may accommodate more than four input and four output pigtails. Input pigtails 1402 may include A1-A6 for six total inputs, and output pigtails 1404 may include B1-B6 for six total outputs. For each of the k schematic signal paths, input Ak may flow into output Bk in substantially the same was as shown and described in FIGS. 1-13. The first physical signal path set 1406 may flow from Ai Bi where i is 1, 2 or 3. The second physical signal path pair 1408 may flow from Aj to Bj where j is 4, 5 or 6. In some embodiments, an isolator core may 1400 include any even number of input and output pigtails.

In some in embodiments, where the isolator core is used in a reverse WDM pump configuration, a portion of optical power generated by a pump may be reflected by mirrors (not pictured) on either side of isolator core back onto adjacent optical pigtails. In some embodiments, where the isolator core is used in a reverse WDM pump configuration, a portion of optical power generated by the pump may be reflected by mirrors (not pictured) on either side of isolator core back onto the input optical pigtail.

In various embodiments, an isolator core may allow the use of more than one isolator core within the IWDM to increase the amount of isolation achieved. In most embodiments, an IWDM and an isolator may be implemented in a single component.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

Embodiments disclosed herein may be embodied as a system, method, or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

What is claimed is:

1. An apparatus comprising:
a first lens; wherein the first lens is enabled to be optically connected to an optical fiber;
an isolator core optically coupled to the first lens;
a second lens optically coupled to the isolator core; wherein the second lens is enabled to be optically connected to another optical fiber;
wherein the isolator core is enabled to allow optical power from the first lens to propagate through the isolator core; wherein the isolator core is enabled to block optical power from the second lens from propagating through the isolator core;
a first optical filter optically coupled to the first lens; and
a second optical filter optically coupled to the second lens; wherein the second optical filter is enabled to reflect a first frequency; wherein the isolator core is enabled to absorb a remaining portion of the first frequency.

2. The apparatus of claim 1, wherein the first optical filter and the second optical filter have different transmission and reflection spectra.

3. The apparatus of claim 1, further comprising:
a second EDFA optically connected to the isolator core opposite a first EDFA.

4. The apparatus of claim 1, wherein the first lens is enabled to be optically connected to a plurality of optical fibers; wherein the second lens is enabled to be optically connected to a plurality of other optical fibers.

5. The apparatus of claim 4, wherein a first portion of the plurality of optical fibers are of a first refractive index profile and material composition; wherein a second portion of the plurality of optical fibers are of a second refractive index profile and material composition.

6. The apparatus of claim 4, wherein a first portion of the plurality of other optical fibers are of a first refractive index profile and material composition; wherein a second portion of the plurality of other optical fibers are of a second refractive index profile and material composition.

7. The apparatus of claim 4 wherein a first portion of the plurality of optical fibers are enabled be an input; wherein a second portion of the plurality of optical fibers are enabled to be an output.

8. The apparatus of claim 1, wherein both the first optical filter and the second optical filter are optical gratings.

9. The apparatus of claim 1 wherein both the first filter and the second filter are dielectric filters.

10. The apparatus of claim 1, wherein the optically directional filter is tuned to directionally permit a specific wavelength.

11. The apparatus of claim 1, wherein the optically directional filter is tuned to directionally reject a specific wavelength.

12. The apparatus of claim 1, wherein optical power is enabled to flow into the first lens from at least one optical fiber; wherein optical power is enabled to flow out of the second lens to at least one other optical fiber.

13. The apparatus of claim 1, wherein optical power is enabled to flow into at least one optical fiber from the first lens; wherein optical power is enabled to flow out of at least one other optical fiber to the second lens.

14. The apparatus of claim 1, wherein optical power of a first wavelength is enabled to flow into the first lens from at least one optical fiber; wherein optical power of a second wavelength is enabled to simultaneously flow out of the first lens into the at least one optical fiber.

15. The apparatus of claim 1, wherein optical power of a first wavelength is enabled to flow out of the second lens into at least one optical fiber; wherein optical power of a second wavelength is enabled to simultaneously flow into the second lens from the at least one optical fiber.

16. The apparatus of claim 1, wherein the isolator core is configured to operate in at least four modes: isolator mode, WDM mode; Isolator-WDM mixed mode; and Reverse-WDM mode.

17. The apparatus of claim 1, wherein the first lens is enabled to connect to two inputs, wherein the second lens is enabled to connect to two outputs.

18. The apparatus of claim 1, wherein the first lens is enabled to connect to four inputs; wherein the second lens is enabled to connect to four outputs.

19. The apparatus of claim 1, wherein the first lens is enabled to connect to at least six inputs; wherein the second lens is enabled to connect to at least six outputs.

20. The apparatus of claim 1, further comprising:
a second isolator core connected to a first EDFA, wherein the isolator core and the second isolator core are each connected to separate optical fibers.
